(19) United States
(12) Patent Application Publication
(10) Pub. No.: US 2002/0099530 A1
(43) Pub. Date: Jul. 25, 2002

(54) Method for automatically generating software

(76) Inventor: Andreas Foltinek, Kornwestheim (DE)

Correspondence Address: SHLESINGER, ARKWRIGHT & GARVEY LLP, 3000 SOUTH EADS STREET, ARLINGTON, VA, 22202, US

(21) Appl. No.: 09/988,229

(22) Filed: Nov. 19, 2001

(30) Foreign Application Priority Data
Nov. 20, 2000 (DE) 100 57 575.7-53

(51) Int. Cl. G06F 9/45

(52) U.S. Cl. 703/22

(57) ABSTRACT

The invention relates to a method for automatically generating software in which the properties of an application made possible by the software are modelled in abstract form and then mechanically converted into software for this application, while the execution of the application influences a technical system optionally made up of a plurality of systems. It is proposed that at least one of the following additional elements is generated in a totally integrated multi-objective form from the modelled description of the application together with the application source code or together with the source information suitable for producing this source code, namely:

software for visualising and/or logging and/or remotely monitoring/operating the application and/or the technical system;

software for simulating the application and/or the technical system;

software and/or information for communicating within the application and/or with other systems and/or between split systems and

documentation for the user and/or the programmer.

The invention relates to a method for automatically generating software in which the properties of an application made possible by the software are modelled in abstract form and then mechanically converted into software for this application, while the implementation of the application influences a technical system optionally made up of a plurality of systems.

To increase effectiveness in the development of software, description-based processes are increasingly used. Independently of conventional programming languages, the properties of an application are modelled in abstract terms and later mechanically converted into software for the application. The advantage of these processes is the significant time saving in development based on a higher level of abstraction, and the elimination of the manual setting up of trivial codes.

For modelling applications, i.e. in order to draft the description of the application, the following methods are known, for example: object orientation (inheritance, overloading, virtualisation etc.); hierarchisation; encapsulation; modularisation; instancing; integration of conventional programming languages and mathematical models; function modelling with abstract models; generators for user interfaces and data structures and their processing.

After modelling, the application source code is automatically generated using the description of the application. Beforehand, various preprocessors and test programmes may be applied to the description of the application within the scope of preprocessing in order to recognise any logic errors, contradictions, pointer errors, dead codes, etc.

As a rule, however, generating the application source code is not enough. For example, documentation may be needed not only for the user but also for the actual programmer. It is also desirable to have software for visualising and simulating the application itself and the technical system influenced by the application, i.e. simulating the external parameters required by the application and the influences on the system produced by the application.

A disadvantage of the existing generating methods is the fact that the additional information and software belonging to the application source code is only generated in a fragmentary manner, or not at all. Consequently, manual setting up or adjustment or separate generation by the parallel use of different methods is required. Since more than just one design source is needed in these cases, the following serious disadvantages arise:

insufficient use of information and possible synergistic effects;

redundant information, leading to a high probability of inconsistencies;

a substantial overall increase in the cost of development and aftercare.

The aim of the present invention is therefore to allow all the necessary information targets to be generated effectively and completely, free from redundancies, from a central design source for a specific application software.

This aim is achieved according to the invention by a method according to claim 1. Advantageous embodiments will become apparent from the subsidiary claims and the description that follows.

In the method according to the invention, all the necessary information targets are generated in a totally integrated form from a new modelled description of the application together with the application source code (or the source information required for this), these information targets comprising at least one of the following additional elements:

software for visualising and/or logging and/or remotely monitoring/operating the application and/or the technical system;

software for simulating the application and/or the technical system and possibly counter-simulating the technical system, i.e. simulating the external influences on and interactions with the technical system;

software and/or necessary information for communicating within the application and/or with other systems and/or between split systems, i.e. between systems which are physically separated but connected by the exchange of data;

documentation for the user of the application and/or for the programmer (designer) of the application.

An important aspect is that the application source code produced according to the invention and the additional elements can run on various platforms irrespective of the platform.

To achieve an advantageous solution, the following boundary conditions must be respected:

modelling of the complete software without any redundancies;

generation of the information targets (sinks) without any adjustment;

generation of the information targets (sinks) independently of programming languages, operating systems and hardware;

supporting split and heterogeneous systems;

direct support of textual/graphic man-machine interfaces;

thoroughly object-oriented approach, e.g. in nomenclature, units, range of values etc. of data;

inclusion of further information (e.g. explanations, help text, comments) in the modelling;

multilingual modelling of the application;

easy total portability/reusability of software components.

The generating process according to the invention proceeds by the following steps:

1. Drafting a description of the application by modelling; the basic make-up (structure) is relevant, but not the concrete expression (syntax). The description is advantageously drafted using suitable editing software (Editor).

2. Optional mechanical preprocessing of the description of the application, e.g. preprocessing and optimisation, and the use of generally known methods for improving/ensuring the quality of the software.

3. Multi-objective fully integrated generation of the data sinks (see additional elements mentioned above).

In the following, the structure of the description of the application will first be described.

The description of the application in the process according to the invention advantageously consists of modules fitting inside one another hierarchically, additional information and instancing tables which contain the application part of a project in full. Advantageously, modules and their additional information are rationally spread over a variety of project or library computer files. One module or one project file typically encapsulates a partial problem of the application.

A module consists in design terms of at least the following groups of definitions which are required as a minimum to provide a total definition but in reality only some of which may occur:

node definitions;

sub-module definitions;

element definitions;

man-machine interface definitions (MMI=man-machine interface);

function definitions.

Each set of definitions may contain as many (individual) definitions as desired. The function and meaning of these individual definitions are described more fully hereinafter.

The other additional information advantageously used for the description of the application contains information such as texts, images, visualisers, type definitions, etc., to which reference is made within the modules. In an advantageous embodiment this additional information is stored with the associated modules in the same project file which then forms a completely self-sufficient and reusable unit.

Finally, instancing tables may advantageously be used for the description of the application, containing information which cannot be deposited directly in the module owing to multiple instancing of the modules and which cannot be generated mechanically either. One example of this is hardware addresses.

The structure of a module for the description of the application in the software generating method according to the invention will be explained hereinafter.

Since the concrete formulation (syntax) of the definitions mentioned above may take many forms, the following description of the sets of definitions will only outline their structure and content in basic terms. All the components defined have the attributes and information required for the sinks (information targets).

Node definitions:

This definition enables the application to be distributed to physically separate hardware systems coupled by data technology (split systems). By using this definition the associated module and its sub-modules (if any) become a logically independent unit. Advantageously, a number of sinks of the same type may be generated from this (e.g. application software for the individual nodes of split hardware systems).

Attributes by way of example are: node name, information text, type of hardware (power), type of communication (address).

Sub-module definitions:

This definition allows sub-modules to be instanced (tied in).

Attributes by way of example are: module name, information text, parameters to be transmitted.

Element definitions:

By elements are meant all the data as well as hardware inputs and outputs of the module. These are assigned a type (e.g. digital, alphanumerical, selective, time, date, etc.) and a category/use (e.g. parameter, status data, measurement data, hardware inputs/outputs, timers, counters, equation data, etc.)

Hardware inputs may also have counter-simulation equations which constitute a virtual imaging of the environmental reactions in order to obtain as realistic a simulation as possible.

Elements may be put together to form structures and n-dimensional fields. Elements are added on in object-oriented fashion, i.e. they allow them to be accessed and displayed, for example, irrespective of the type and the category/use.

Attributes by way of example are: element name, information text, data type, category (use), standard value, range of values, unit, display/editing rights, hardware association, counter-simulation equations.

Man-machine interface definitions:

These all comprise MMI (man-machine interface) parts belonging to a module for the application and for the additional elements generated according to the invention (information targets, sinks). Advantageously, the MMI definition is broken down again into sub-groups, so-called surfaces, one surface containing a completed part of the MMI (e.g. parameter processing, status display, process visualisation, etc.).

The actual MMI definition may, for example, be carried out with the following commands:

text, image, line, rectangle, circle, bitmap, definition of sub-images;

show elements (as text or in graphic form), show histograms;

pages, menus, lists, toolbars (buttons);

actions (manipulation of elements, choosing options in the menus, pages, surfaces);

conditional parts of surfaces depending on elements.

Moreover, when displaying elements, the object-oriented attributes thereof such as the name, description, unit and display attributes are automatically used.

Function definitions:

The function definition of a module consists of any desired number of functions. The nature of the description may also take any form, including a mixed form, e.g. produced by conventional programming languages, abstract models, etc., and is optionally converted by external compilers.

A function typically contains a logical partial function of the module and has attributes with which the operating system of the target system can control the execution (e.g. permanent execution, time-critical/non-critical, call-up frequency, event-triggered, MMI-triggered).

Advantageously, the function definition may go back to the elements.

After this description of the modular structure the properties of an advantageous description of an application will now be explained in terms of design:

modules may be requested in parallel and/or hierarchically as desired and may pass on their properties to other modules.

The instancing of the modules is effected by means of global instancing lists, or selectively, directly in the module, in the case of single instancing.

Modules may also be modelled as self-contained units, i.e. they contain all the necessary information locally and can therefore be reused/transferred very easily.

The use of libraries is possible for modules as well as for additional information in every type of information mentioned (texts, images, visualisers, data types, functions, etc.)

Element and module attributes are treated in object-oriented manner (virtuality).

All the components of a description of an application are assigned further information, this information being sent to all the sinks.

The information from one or more modules is stored in a file. Sub-modules (if they are to be further used) and libraries are stored in separate files.

The resolution of complex applications with split and optionally heterogeneous hardware or with multiprocessor systems advantageously takes place in a central description in which the distribution of the modules is described statically or dynamically.

After a description of an application has been undertaken in accordance with the model structures mentioned above, the description of the application can be mechanically preprocessed in order to achieve optimisation, quality assurance and analysis and check for errors and contradictions. This preprocessing is largely dependent on the general syntax used and on the forms of description used within the functions. Since both can be designed as required, the software conversion of the preprocessing is not relevant here.

According to the invention, the various information targets (sinks, additional elements to the actual application source information) can now be formed mechanically or automatically using a target generator.

Since the precise construction of the sinks depends on the target system, programming language, compiler, PC platform, etc., only the properties of the sinks which form part of the invention are described. In general terms it is true of all the sinks according to the invention that they are generated directly as described below and/or the information (source code and/or tables/lists and/or binary data and/or other forms of software information) which makes it possible for them to be produced by other external systems is generated. Generation results may be:

Application data

structures for (object-oriented) management of the modules

structures for (object-oriented)management of the elements

application functions

application MMI (if present in the application)

text/graphics in multilingual form (if present in the application)

in split systems correspondingly individualised information may be generated for the individual hardware nodes.

The information generated is independent of compiler, operating system and target hardware.

PC/Web visualisation

Structures for (object-oriented) communication with the application hardware

Structures for (object-oriented) administration of the elements

visualisation MMI

text/graphics in multilingual form

PC Offline simulation

application definition (see above)

PC/web visualisation (see above, in addition to the elements for executing counter-simulation)

User documentation

list of parameters (including attributes)

list of status/measuring data

list of inputs/outputs

information on the functions of the application (if present in the description of the application)

overview of the MMI structure (if present in the application)

detailed representation of the individual parts of the MMI and information as to their operation and function (if present in the application)

Software documentation

user documentation (see above)

modular structure (links)

information on the structuring of the modules with one another

information on the module contents (including functionality)

Compared with existing software generating methods the process according to the invention has the following advantages:

There is only one software description, which is free from redundancies;

All the information targets/sinks are fully capable of being generated;

Inconsistencies are impossible within a sink and between the individual sinks;

No manual adjustment of the individual sinks is required;

Total integrated support of the man-machine interface;

High-level use of the object-oriented modelling of modules and elements, particularly within the scope of the man-machine interface.

To sum up, the work of development, documentation and aftercare in the generation of software is substantially shortened.

Some embodiments by way of example will now be described in more detail with reference to the accompanying drawings to illustrate the invention and its advantages.

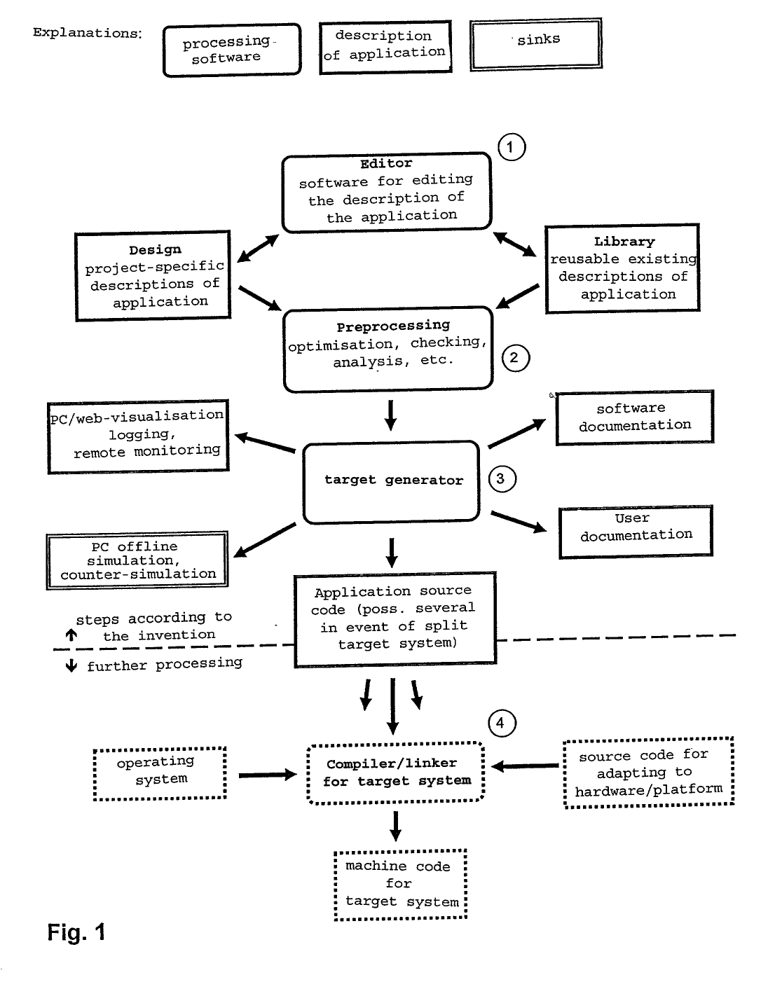

FIG. 1 shows a highly simplified representation of a possible embodiment of the design flow for generating software according to the invention.

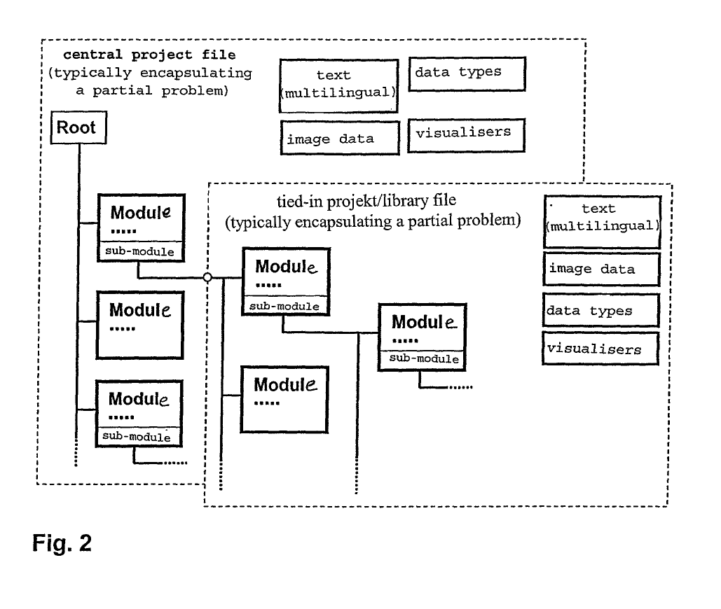

FIG. 2 shows, by way of example, the hierarchisation of the application, i.e. the structure of a description of an application by way of example which consists of a central project file and a tied-in project file.

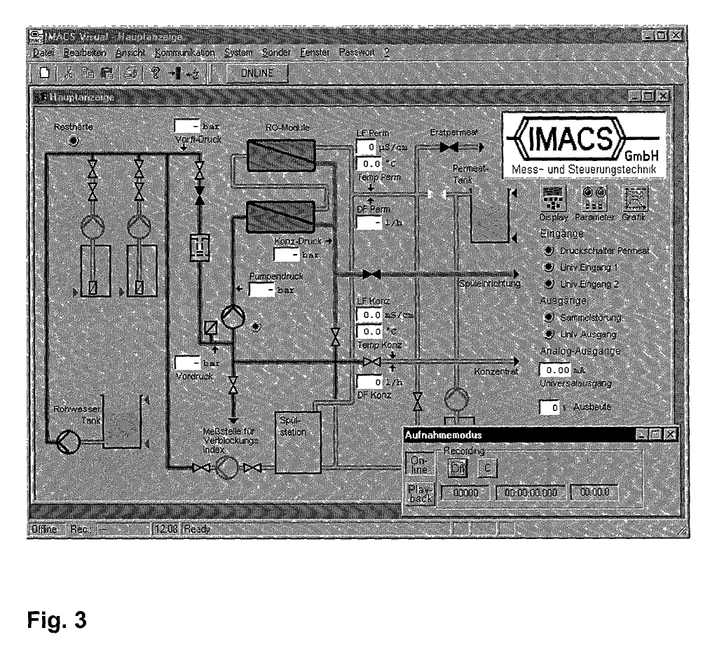

FIG. 3 shows a soft copy by way of example which can be produced using the software generated according to the invention for visualisation or simulation.

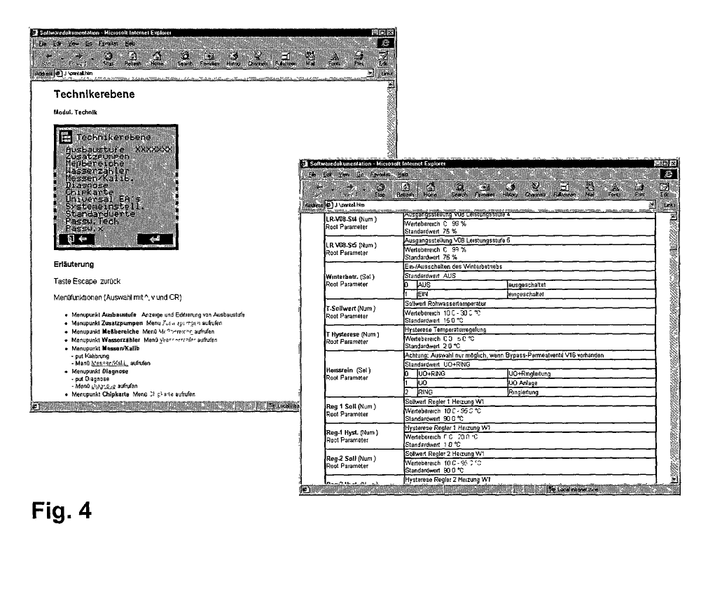

FIG. 4 shows an example of software documentation produced by the method according to the invention shown on-screen.

FIGS. 1 and 2 diagrammatically explain, by way of example, the design flow and application hierarchisation in the generation of software according to the invention.

An example of an application will now be described in detail.

Statement of the problem:

Automatically testing the hardness of a workpiece by the penetration of a conical steel point into the testpiece in the following sequence:

1. application of the testing force

2. waiting while the testing time elapses

3. reading the results of the measurement

4. if the test is in order => sending the testpiece onwards

if the test is not in order => discarding the testpiece as a reject

5. continuing with 1.

The following requirements apply with regard to the system of automation:

The testing force is applied by releasing a cylinder and regulating the testing force by means of the cylinder pressure (internal regulation).

The correct application of the testing force is indicated by the testing machine by a digital feedback (sensor). In the absence of a signal (after a certain length of time) the machine switches over to an error state.

The actual hardness testing is done with a separate distance measuring device which transmits the depth of penetration to the automated system in the form of an analogue signal. The application compares this with a rated value and decides between “in order” (=i.o.) or “not in order” (=n.i.o.).

The test results are made available to an external unit in the form of an i.o. or n.i.o. output.

Using an MMI inside the apparatus the parameters should be variable and the actual status of the apparatus should be indicated.

Using a serial interface an external visualisation unit should be attached which displays all the information of the MMI inside the apparatus and the force/distance pattern of a test. This software as well as software for offline simulation is generated in parallel from the same source.

The automation system has:

Hardware inputs and outputs:

starting signal (for starting a test) (digital output)

end position feedback for the application of testing force (digital input)

activation of the application of the testing force (digital output)

IO message (digital output)

NIO message (digital output)

preset cylinder pressure (analogue output)

measurement input: testing force (analogue input)

measurement input: depth of penetration (analogue input)

Parameters:

Time limit for “advance” (of the application of force until the sensor is reached) (in seconds)

testing time (in 1/10 sec)

testing force (prescribed value in 1/10 kN)

max. depth of penetration (in μm)

min. depth of penetration (in μm)

P component of the force PI regulator

I component of the force PI regulator

### Description and Modelling of the Application

In accordance with the problem described, a solution is modelled which consists of the modules ModTest (basic control of the test procedure) and ModRegPI (PI regulator) and additional information. The ModRegPI module is of a library type and may already be present in a library or attached to one. In reality the ModTest module may also be used in larger processes as a sub-module.

Additional Information:

The following additional information is set up:

Texts: multilingual text table containing all the texts used

Images: definition of all the images/graphics required in the modules

Data types:

| TOffOn: | selective, possible states: ON and OFF |
|---|---|
| TForce: | digital, in [kN], 1 decimal place, range: |
| | 0.0 . . . 99.9 |
| TDepth: | digital, in [μm], no decimal places, range: |
| | 0 . . . 2000 |
| TPressure: | digital, in [bar], 1 decimal place, range: |
| | 0.0 . . . 15.0 |
| TSec: | digital, in [s], 1 decimal place, range: |
| | 0.0 . . . 60.0 |
| TPerc: | digital, in [%], no decimal places, range: |
| | 0 . . . 200 |

Visualiser:

Definitions of the manner in which data/information is displayed in the MMI.

“ModTest” Module:

Sub-modules:

One instance of module ModReg. Instance name: MRegulator

Elements:

| | |
|---|---|
| Start: | Trigger input for starting a test |
| | Data type: TOffOn, category: dig. input |
| End position: | Feedback end position reached |
| | Data type: TOffOn, category: dig. input |
| Cylinder: | Release of testing force cylinder |
| | Data type: TOffOn, category: dig.output |
| IO message: | IO message to an external unit |
| | Data type: TOffOn, category: dig.output |
| NIO message: | NIO message to an external unit |
| | Data type: TOffOn, category: dig.output |
| Depth of penetration: | Results of measurement after test |
| | Data type: TDepth, category: analogue |
| | input |
| Testing force: | Measured testing force (actual value) |
| | Data type: TForce, category: analogue |
| | input |
| min. depth of penetration: | lower threshold for penetration |
| | Data type: TDepth, category: parameters |
| max. depth of penetration: | upper threshold for penetration |
| | Data type: TDepth, category: parameters |
| Test period: | duration of penetration |
| | Data type: TSec, category: parameters |

MMI control system (two-line display):

if current state is not equal to READY (=i.e. it is being tested) top line: current depth of penetration bottom line: IO/NIO message

other (=i.e. it is not being tested) top line with main menu message bottom line: display of a line from the main menu. Here, the parameters can be viewed and changed.

MMI Visualisation system (PC under Windows):

Representation of the measured data and the test parameters in graphic form, possibly spread over several windows

| | |
|---|---|
| Functions: | |
| (here carried out | |
| as a status machine) | |
| READY status: | On entry: Inactivate/activate the outputs |
| | Cylinder, IO message and NIO message. |
| | If input Start is active, go to status |
| | CYLINDER ON |
| CYLINDER_ON status: | On entry: Activate the output Cylinder, |
| | start the time |
| | If input End position is active, go to |
| | status MEASURE |
| | If time > 3 s, go to status |
| | CYLINDER ON |
| MEASURE status: | On entry: from the sub-module MRegulator |
| | activate the Release flag, start the time |
| | If (time > test period) AND (depth of |
| | penetration < min. depth of penetration), |
| | go to status TEST_NIO |
| | If (time > test period) AND (depth of |
| | penetration > max. depth of penetration), |
| | go to status TEST_NIO |
| | Otherwise, if (time > test period), go to |
| | status TEST_IO |
| TEST_IO status: | On entry: from the sub-module MRegulator |
| | inactivate the Release flag, activate the |
| | IO message output, inactivate the Cylinder |
| | output, start the time |
| | If time > 3 s, go to status READY |
| TEST_NIO status: | On entry: from the sub-module MRegulator |
| | inactivate the Release flag, activate the |
| | NIO message output, inactivate the Cylinder |
| | output, start the time |
| | If time > 3 s, go to status READY |
| ERROR status: | Not further specified |
| “ModRegPI” Module: | |
| Sub-modules: | |
| none | |
| Elements: | |
| Release: | Trigger input for starting a test |
| | Data type: TOffOn, category: dig. |
| | input |
| Testing force: | Measurement of testing force |
| | (actual value) |
| | Data type: TForce, category: analogue input |
| Testing pressure: | Measurement of testing force |
| | (actual value) |
| | Data type: TPressure, category: |
| | analogue output |
| P component: | P component of force regulation |
| | (via pressure output) |
| | Data type: TPerc, category: parameters |
| I component: | I component of force regulation |
| | (via pressure output) |
| | Data type: TPerc, category: parameters |

MMI Control system:

not further specified

MMI Visualisation system:

not further specified

Functions: (e.g. as a real-time C-Code)

Rule algorithm, not further specified

Generating results:

Application code:

The source code generated in this example of an application contains the following components:

lists of the elements in which all the necessary information and attributes are deposited

classes/structures for the modules added on

structures/instances for data description

structures/instances for MMI description which are executed by an interpreter on the target hardware

various function code parts which have been partially generated from a status machine

Visualisation:

This is shown in FIG. 3 (albeit with reference to a different embodiment).

Offline simulation:

The offline simulation basically consists of the visualisation (cf. FIG. 3) and the application code compiled for a PC. The two parts are coupled internally, while the counter-simulation produces an almost realistic behaviour. Optically, the simulation corresponds substantially to the visualisation.

Documentation:

This is shown in FIG. 4 (albeit with reference to a different embodiment).

FIG. 3 (German terms and their English equivalents)

IMACS Visual Main Display

Hauptanzeige=Main Display

Resthärte=residual hardness

RO-Module=RO modules

Erstpermeat=first permeate

Temp Perm=permeate temperature

Permeat-Tank=permeate tank

Vorfl-Druck=drainage pressure

Pumpendruck=pump pressure

Konz-Druck=conc. pressure

DF Perm=permeate flow

Vordruck=supply pressure

Rohwasser Tank=untreated water tank

MeBstelle fur Verblockungsindex=measuring point for blocking index

Spülstation=rinsing station

Spüleinichtung=rinsing device

Temp. Konz.=temp. conc.

DF Konz.=concentrate flow

Konzentrat=concentrate

Eingänge=inputs

Druckschalter Permeat=pressure switch permeate

Univ. Eingang 1=univ. input 1

Univ. Eingang 2=univ. input 2

Ausgänge=outputs

Sammelstörung—collecting interference

Univ. Ausgang=univ. output

Analog-Ausgänge=analogue outputs

Ausbeute=yield

Aufnahmemodus=recording mode

FIG. 4 (in its English translation)

Software documentation—Microsoft Internet Explorer

Technical level

Module:

Technology

Technical Level

Extension Level

Additional Pumps

Measuring Ranges

Water Meter

Measuring/Calibration

Diagnosis

Chip Card

Universal I/Os

System Settings

Standard Values

Password Tech.

Password x

Explanation:

Escape key: back

Menu functions (Selection with , V and CR):

menu point extension level: displaying and editing extension level

menu point Additional pumps: call up Additional pumps menu

menu point Measuring ranges: call up Measuring ranges menu

menu point Water meter: call up Water meter menu

menu point Measuring/calibration:

put calibration

call up Measuring/calibration menu

menu point Diagnosis

put diagnosis

call up Diagnosis menu

menu point Chip card: call up Chip card menu

FIG. 4 (continuation)
Software documentation—Microsoft Internet Explorer

| | |
|---|---|
| LR-V08-St4 (num.) | starting position V06 power stage 4 |
| root. parameter | range of values: 0-99% |
| | standard value: 75% |
| LR-V08-St4 (num.) | starting position V08 power stage 5 |
| root. parameter | range of values: 0-99% |
| | standard value: 75% |
| winter op. (sel.) | switching winter op. on/off |
| root. parameter | standard value: OFF |

| | | |
|---|---|---|
| 0 | OFF | switched off |
| 1 | ON | switched on |

| | |
|---|---|
| T-rated value (num.) | rated value for crude water temperature |
| root. parameter | range of values: 10.0-30.0° C. |
| | standard value: 15.0° C. |
| T hysteresis (num.) | hysteresis temperature regulation |
| root. parameter | range of values: 0.0-5.0° C. |
| | standard value: 2.0° C. |
| Hot clean. (sel.) | Note: choice only possible if bypass |
| root. parameter | permeat valve V16 provided |
| | standard value: UO + RING |

| | | |
|---|---|---|
| 0 | UO + RING | UO + ring pipe |
| 1 | UO | UO apparatus |
| 2 | RING | ring pipe |

| | |
|---|---|
| Reg-1 rated (num.) | Rated value Regulator 1 Heating W1 |
| root. parameter | range of values: 10.0-95.0° C. |
| | standard value: 90.0° C. |
| Reg-1 hyst. (num.) | Hysteresis Regulator 1 Heating W1 |
| root. parameter | range of values: 0.0-20.0° C. |
| | standard value: 1.0° C. |
| Reg-2 rated (num.) | Rated value Regulator 2 Heating W1 |
| root. parameter | range of values: 10.0-95.0° C. |
| | standard value: 90.0° C. |

1. Method for automatically generating software in which the properties of an application made possible by the software are modelled in abstract form and then mechanically converted into software for this application, while the execution of the application influences a technical system optionally made up of a plurality of systems, characterised in that at least one of the following additional elements is generated in a totally integrated multi-objective form from the modelled description of the application together with the application source code or together with the source information suitable for producing this source code, namely:
software for visualising and/or logging and/or remotely monitoring/operating the application and/or the technical system;
software for simulating the application and/or the technical system;
software and/or information for communicating within the application and/or with other systems and/or between split systems and
documentation for the user and/or the programmer.

2. Method according to claim 1, characterised in that in addition to the software for simulating the application, software for counter-simulating the technical system which is influenced by the application is also generated.

3. Method according to claim 1, characterised in that the application is modelled by one or more modules, additional information and possible instancing tables, wherein
one module advantageously contains a partial problem of the application,
the additional information contains information such as text, images, visualisers and type definitions to which reference is made within the modules, and
the instancing tables contain information which cannot be deposited directly in the module itself in the event of multiple instancing of the modules and which cannot be generated mechanically either, such as hardware addresses, for example.

4. Method according to claim 3, characterised in that a module is totally defined by the following sets of definitions:
node definitions for distributing the application to physically separate hardware systems coupled by data technology (split systems),
sub-module definitions for instancing (tying-in) sub-modules,
element definitions for combining all the data as well as hardware and communication inputs/outputs of a module,
man-machine interface definitions for defining all the components required within a module for producing an interface for the user and
function definitions consisting of a number of functions of a module.
